(19) United States
(12) Patent Application Publication
(10) Pub. No.: US 2012/0188105 A1
(43) Pub. Date: Jul. 26, 2012

(54) SYSTEM FOR MONITORING THE POSITION OF VEHICLE COMPONENTS

(75) Inventor: Rakan Khaled Y. Alkhalaf, Riyadh (SA)

(73) Assignee: Rakan Khaled Y. ALKHALAF, Riyadh (SA)

(21) Appl. No.: 13/499,227

(22) PCT Filed: Sep. 30, 2009
(86) PCT No.: PCT/EP09/62717

§ 371 Date: Mar. 29, 2012

(51) Int. Cl. G08G 1/123

(52) U.S. Cl. 340/989

(57) ABSTRACT

In various embodiments, a vehicle (100) may include a plurality of position sensors (102) arranged at predetermined points on the vehicle and/or on one or more vehicle components; a positioning sensor device configured to provide data related to the spatial positions of the plurality of position sensors; a location detection device (106) configured to detect the location of the vehicle; a data collector configured to collect the data provided by the positioning sensor device and the location detection device; a data processor configured to process the data collected by the data collector; and a data transmitter (112) configured to transmit the data processed by the data processor to an external receiver.

### TECHNICAL FIELD

Various embodiments relate to vehicles.

### BACKGROUND

In the past, evaluation of the damage caused to a vehicle, for example during an accident or during operation of the vehicle under rough conditions, required inspection of the vehicle, for example in a workshop. This can be quite dangerous, for example when important parts of a car are damaged during operation under rough road conditions and the driver of the car, not noticing or underestimating the damage, unwittingly continues his travel. Such a situation might lead to an accident, thus endangering both the occupants of the vehicle itself and also the occupants of other vehicles. Moreover, continuation of the travel under such circumstances might result in an even increasing damage, thus for example also increasing the repair costs.

Moreover hitherto, in case of an accident, e.g. a car accident, a first evaluation of the severity of possible injuries to the vehicle occupants resulting from the accident was only possible on the basis of descriptions of the crash scene by eye witnesses. In case that, for example, the accident happens in a sparsely populated area so that there is nobody around to describe the crash scene and/or there is no possibility to communicate with the responsible public authorities and/or the occupants of the vehicle are not responsive, this might lead to dangerous or even life-threatening situations.

### SUMMARY OF THE INVENTION

In various embodiments, a vehicle may include a plurality of position sensors arranged at predetermined points on the vehicle and/or on one or more vehicle components; a positioning sensor device configured to provide data related to the spatial positions of the plurality of position sensors; a location detection device configured to detect the location of the vehicle; a data collector configured to collect the data provided by the positioning sensor device and the location detection device; a data processor configured to process the data collected by the data collector; and a data transmitter configured to transmit the data processed by the data processor to an external receiver.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a block diagram schematically showing a vehicle comprising a vehicle status monitoring arrangement in accordance with an embodiment;

FIGS. 2A and 2B show a functional principle of a method of determining a shape and/or deformations of a shape of a portion of a vehicle according to an embodiment;

FIGS. 3A and 3B show a functional principle of a method of determining a positioning of a vehicle component and/or displacements of a vehicle component according to an embodiment;

FIG. 3C shows a functional principle of a method of detecting broken and/or deformed vehicle components according to an embodiment;

FIGS. 4A and 4B show an aspect of a redundant design of components of a vehicle status monitoring arrangement in accordance with an embodiment;

FIG. 5A shows a block diagram schematically illustrating a vehicle including a vehicle status monitoring arrangement in accordance with an embodiment, wherein the positioning sensor device is an RFID based sensor device;

FIG. 5B shows a signal exchange between an interrogator and an RFID tag in the embodiment shown in FIG. 5A; and

FIG. 6 shows a block diagram illustrating a vehicle including a vehicle status monitoring arrangement in accordance with another embodiment.

### DESCRIPTION

The following detailed description refers to the accompanying drawings that show, by way of illustration, specific details and embodiments in which the invention may be practiced. These embodiments are described in sufficient detail to enable those skilled in the art to practice the invention. In this regard, directional terminology, such as “top”, “bottom”, “front”, “back”, “leading”, “trailing”, etc, is used with reference to the orientation of the Figure(s) being described. Because components of embodiments can be positioned in a number of different orientations, the directional terminology is used for purposes of illustration and is in no way limiting. Other embodiments may be utilized and structural, logical, and electrical changes may be made without departing from the scope of the invention. The various embodiments are not necessarily mutually exclusive, as some embodiments can be combined with one or more other embodiments to form new embodiments. The following detailed description therefore, is not to be taken in a limiting sense, and the scope of the present invention is defined by the appended claims.

The word “exemplary” is used herein to mean “serving as an example, instance, or illustration”. Any embodiment or design described herein as “exemplary” is not necessarily to be construed as preferred or advantageous over other embodiments or designs.

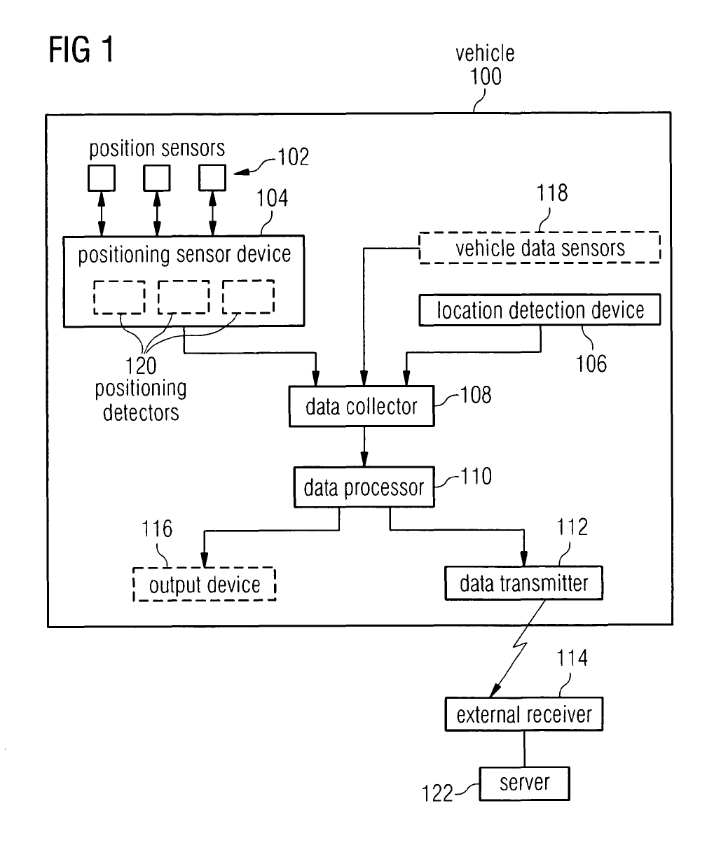

FIG. 1 is a block diagram schematically showing a vehicle 100 including a vehicle status monitoring arrangement according to an embodiment. Referring to FIG. 1, a vehicle status monitoring arrangement according to an embodiment may include a plurality of position sensors 102, a positioning sensor device 104, a location detection device 106, a data collector 108, a data processor 110, and a data transmitter 112. Moreover, the vehicle status monitoring arrangement may include an output device 116 and/or various vehicle data sensors 118, or sensor chips, equipped with corresponding software, such as different acceleration sensors, wheel speed sensors, temperature sensors, and the like.

The position sensors 102 may be securely attached to predetermined and well-defined points on the vehicle and/or on one or more vehicle components, so as to reflect the three dimensional shape of the vehicle and/or the three dimensional shape of predetermined portions of the vehicle and/or the spatial positions of predetermined vehicle components.

The positioning sensor device 104 may interact with the position sensors 102 so as to generate data related to the spatial positions of the position sensors 102. The positioning sensor device 104 may include a number of components, for example one or more positioning detectors 120, each interacting with one or more of the plurality of position sensors 102 in order to generate data related to the spatial positions of the position sensors 102. The positioning sensor device 104 and/or the components constituting the positioning sensor device 104 may also be securely attached to predetermined and well-defined points on the vehicle and/or on one or more vehicle components.

The location detection device 106 may be configured to detect the location of the vehicle 100. The location detection device 106 may be or include, for example, a satellite-based detection device (e.g. a satellite-based positioning system) such as a global positioning system (GPS) receiver. For example, a purpose of the location detection device 106, for example the GPS receiver or GPS chip, can be to have accurate information on the location or position of the vehicle 100. In some embodiments, the GPS receiver can be a special kind of GPS device known as 3-Dimensional Millimeter GPS, which may detect multi satellites at once.

The data collector 108 collects the data generated by the positioning sensor device 104 and the location detection device 106. Moreover, the data collector 108 can be configured to collect data provided by the vehicle data sensors 118. The vehicle data sensors 118 may include various sensors configured to provide data related to the vehicle 100. The vehicle data sensors 118 may, for example, include a speed sensor and/or an acceleration sensor and/or a chip for gathering all of the vehicle's system information such as for example, in the case of the vehicle 100 being a car, the cars light information, the interior temperature, the temperature of the car engine, the brakes' performance, the oil rate and quality, the gasoline properties, the movement and the direction of the tires etc. in order to get the maximum analysis of the car condition. The speed sensor can provide data on the speed of the vehicle 100. The acceleration sensor or accelerometer chip may provide data on the positioning of the vehicle 100 in three dimensional space, for example when an accident occurs the acceleration sensor can be used to determine if and how the vehicle 100 somersaulted, more particular to determine if the vehicle somersaulted from the right, left, back or front, how many somersaults it performed, or if it is positioned in a sloped angle. Moreover, the vehicle data sensors 118 may include a compass device in order to know how the vehicle is directed and/or to determine a traveling direction of the vehicle. The compass device can be, for example, a magnetic compass or an electronic compass depending on the earth's magnetic field for operation. However, the compass device can also be an electronic device which does not depend on the earth's magnetic field such as an astrocompass determining the direction through the positions of various astronomical bodies or a gyrocompass being based on a fast-spinning wheel and friction forces.

The data processor 110 processes the data collected by the data collector 108. The data processor 110 may inter alia be configured to process the data related to the spatial positions of the plurality of position sensors 102 as provided by the positioning sensor device 104 so as to calculate data on the spatial positions and/or on changes in the spatial positions of the plurality of position sensors 102. Moreover, the data processor 110 can be configured to communicate with other components of the vehicle status monitoring system, for example with the positioning sensor device 104 and/or with the vehicle data sensors 118, for example to initiate routines such as a system check of the vehicle status monitoring arrangement and/or collection of a reference data pattern.

According to various embodiments, the data processor 110 can calculate the spatial position of each of the position sensors 102. The positions of the position sensors 102 can be calculated with respect to a specified coordinate system, where the coordinate system can for example be determined with respect to the positioning sensor device 104 or with respect to the positions of various components of the positioning sensor device 104, such as for example various positioning detectors 120.

In another embodiment, the data processor 110 may be configured to evaluate changes in the data originating from each of the position sensors 102 with respect to a reference data pattern stored in the data processor 110. The reference data pattern can be a fixed reference data pattern, for example a factory-provided reference data pattern. In another embodiment, the reference data pattern can be an adjustable data pattern which is collected under predetermined circumstances. For example, the adjustable reference data pattern can be collected in response to manual operation of a specified switch by a vehicle occupant, the switch being installed on the vehicle 100 for this purpose. Or, the adjustable reference data pattern can be collected automatically at the beginning of each travel of the vehicle 100, for example the collection of the adjustable reference data pattern can be implemented as part of the startup procedure of the vehicle 100.

The use of such an adjustable reference data pattern can, for example, be used to account for varying loadings of the vehicle 100 such as a varying number of vehicle occupants or loading of different amounts of different materials. Depending on the type of positioning sensors 102 and positioning sensor device 104 used, varying loadings might influence the interaction between the positioning sensors 102 and the positioning sensor device 104, for example due to varying physical properties of the loading material such as different electromagnetic properties of different materials influencing the signal exchange between the positioning sensors 102 and the positioning sensor device 104. In such cases, where the interaction between the positioning sensors 102 and the positioning sensor device 104 depends on varying boundary conditions, it may be provided to first collect a reference data pattern reflecting the present boundary conditions and then compare subsequently collected data to this reference data pattern.

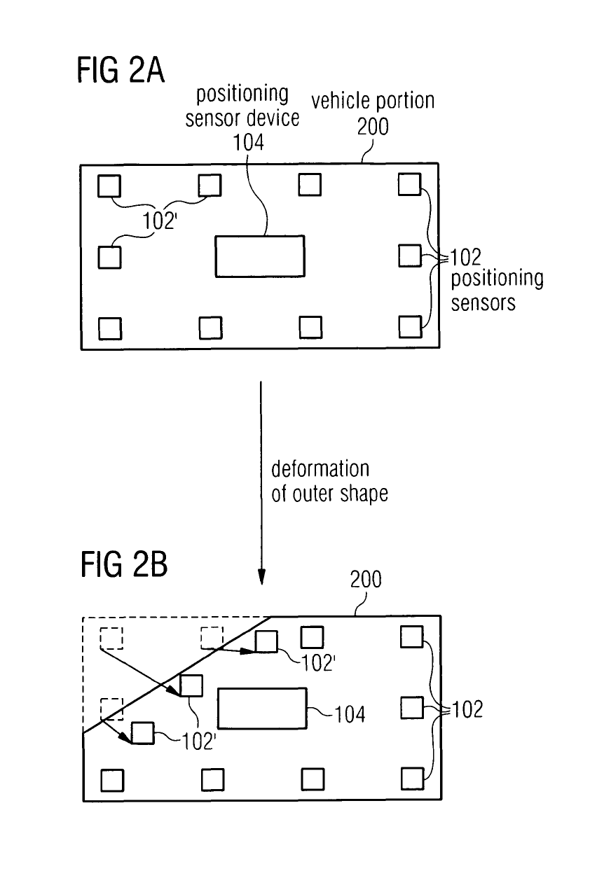

In an embodiment, the data processor 110 may be configured to evaluate the data on the positions or on changes in the positions of the plurality of position sensors 102 to determine the shape and/or changes in the shape of predetermined portions of the vehicle 100, as schematically illustrated in FIGS. 2A, 2B. FIG. 2A schematically depicts a non-deformed portion 200 of the vehicle 100 in two dimensions, including a positioning sensor device 104 and a plurality of position sensors 102 securely arranged at predetermined points on an outer periphery of the vehicle portion 200 so as to accurately reflect the shape of the vehicle portion 200. The vehicle portion 200 can be, for example, a passenger cabin of a car or an airplane, or the hull of a ship. In FIG. 2A, the position sensors 102 are in their original positions reflecting the non-deformed shape of the vehicle portion 200.

FIG. 2B schematically depicts the same vehicle portion 200 as shown in FIG. 2A after a deformation of the vehicle portion 200, for example during an accident of the vehicle 100. In the example depicted in FIG. 2B, the upper left corner of the vehicle portion 200 is bent inwards, which results in displacements of the three position sensors 102′ arranged in this area. The displacements of the three position sensors 102′ result in a change in the data associated with these three position sensors 102′. As described above, the data processor 110 can calculate data on the positions or on changes in the positions of the plurality of position sensors 102, e.g. of the displaced position sensors 102′, in the deformed state of the vehicle portion 200, for example by direclty determining the spatial positions of the position sensors 102 or by comparing the data pattern associated with the deformed vehicle portion 200 with a reference data pattern associated with the non-deformed vehicle portion 200. In an embodiment, the data processor 110 can be configured to use the data on the positions or on changes in the positions of the plurality of position sensors 102 to determine the shape of the vehicle portion 200 or changes in the shape of the vehicle portion 200, for example applying interpolation methods interpolating the positions of sections of the outer periphery of the vehicle portion 200 situated between adjacent position sensors 102. This may allow to detect deformations of predetermined portions of the vehicle 100.

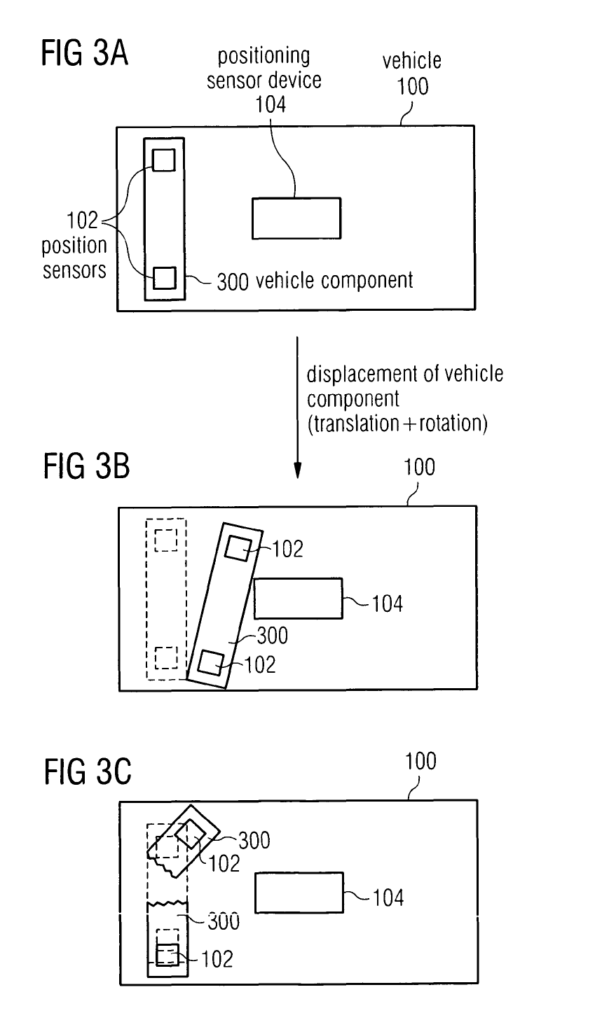

In another embodiment, the data processor 110 may be configured to use the data on the positions or on changes in the positions of the plurality of position sensors 102 to determine displacements of predetermined vehicle components, as schematically illustrated in FIGS. 3A, 3B. FIG. 3A schematically depicts a vehicle 100 including a positioning sensor device 104 and a vehicle component 300 in two dimensions. A plurality of position sensors 102, in the example depicted in FIGS. 3A, 3B, 3C illustrated by two position sensors 102, may be securely attached to predetermined points on the vehicle component 300 so as to accurately reflect the positioning and the shape or the structure of the vehicle component 300. The vehicle component 300 can be located inside or outside of the vehicle 100. The vehicle component 300 can be, for example, an axis of a car or a train waggon, a rudder of a ship or an aircraft or the like. In FIG. 3A, the position sensors 102 are in their original positions reflecting the non-displaced positioning of the non-deformed vehicle component 300.

FIG. 3B schematically depicts the same vehicle 100 as shown in FIG. 3A, after the vehicle component 300 has been displaced, for example due to operation of the vehicle 100 under rough conditions. In the example depicted in FIG. 3B, the vehicle component 300 is both translated to the right side of the vehicle 100 and rotated clockwisely, which results in different displacements of the two position sensors 102 attached to the vehicle component 300. The displacements of the two position sensors 102 result in a change in the data associated with these two position sensors 102. As described above, the data processor 110 can be configured to calculate data on the positions or on changes in the positions of the position sensors 102 attached to the displaced vehicle component 300, for example by directly determining the spatial positions of the position sensors 102 or by comparing the data pattern associated with the displaced vehicle component 300 with a reference data pattern associated with the non-displaced vehicle component 300. In an embodiment, the data processor 110 can be configured to use the data on the positions or on changes in the positions of the position sensors 102 attached to the vehicle component 300 to determine the positioning of the vehicle component 300 or changes in the positioning of the vehicle component 300. This may allow to detect displacements of predetermined components of the vehicle 100. Moreover, this method can be adapted to detect broken or deformed vehicle components, as self-explanatory schematically depicted in FIG. 3C.

Although the above examples used two dimensions, the use of three dimensions may be provided in alternative embodiments. Moreover, it may be provided to increase the number of position sensors 102, thereby increasing the accuracy of the methods described above.

As already mentioned above, the positioning sensor device 104 may include a number of components, for example one or more positioning detectors 120, each interacting with one or more of the plurality of position sensors 102. In some embodiments, the use of more than one positioning detector 120 can be provided to enable the data processor 110 to determine the spatial positions of the position sensors 102 with respect to all three spatial dimensions. In other embodiments, more than one positioning detector 120 can be used to increase the reliability of the vehicle status monitoring arrangement by providing redundancy.

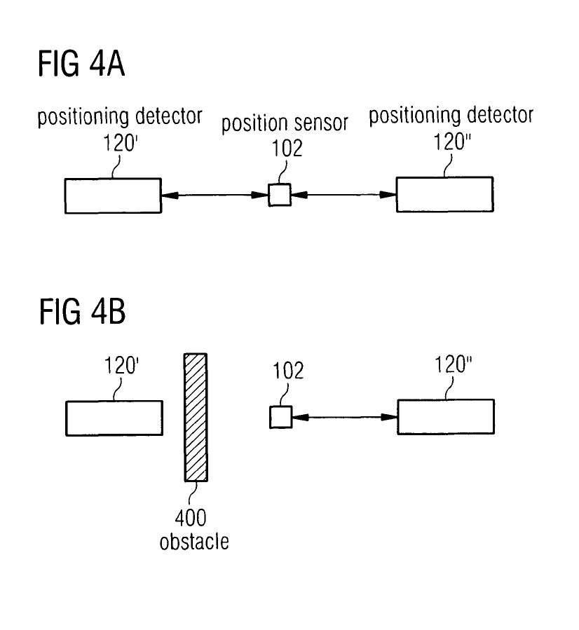

Such redundant arrangement components can also be provided, if for example interaction between a respective one of the position sensors 102 and a respective one of the positioning detectors 120 is not possible due to some reason. For example, the loading of the vehicle can hinder the interaction between a respective one of the position sensors 102 and a respective one of the positioning detectors 120, a possible example of such a situation being shown in FIGS. 4A, 4B. FIGS. 4A, 4B schematically depict a situation, where a position sensor 102 interacts with a positioning detector 120′ positioned to the left of the position sensor 102 and with a positioning detector 120″ positioned to the right of the position sensor 102. FIG. 4A illustrates a situation where both interaction between the position sensor 102 and the positioning detector 120′ and interaction between the position sensor 102 and the positioning detector 120″ is possible.

FIG. 4B depicts a situation where interaction between the position sensor 102 and the positioning detector 120′ is hindered by an obstacle 400 positioned between the positioning detector 120′ and the position sensor 102. However, since interaction between the positioning detector 120″ and the position sensor 102 is still possible, the data associated with the position sensor 102 will not be lost. The obstacle 400 can be a an object physically hindering the interaction between the positioning detector 120′ and the position sensor 102, for example an opaque object preventing optical interaction by means of light, or an object with specific electromagnetic properties preventing interaction by other electromagnetic radiation. However, the obstacle 400 can also be a non-physical object, for example interaction between the positioning detector 120′ and the position sensor 102 can be hindered by disturbing signals occurring between the positioning detector 120′ and the position sensor 102. FIG. 4B illustrates the situation where interaction between a positioning detector 120′ and a position sensor 102 is hindered. This case can be generalized to cases where one or more positioning detectors 120 and/or one or more position sensors 102 are hindered to interact with their counterparts. For example, if interaction between a first positioning detector and a first position sensor is not possible while interaction between the first positioning detector and a number of other position sensors is possible, this can imply that the first position sensor is screened by some object. In another example, if interaction between a second position sensor and a second positioning detector is not possible while interaction between the second position sensor and a number of other positioning detectors is possible, this can imply that the second positioning detector is screened by some object.

In some embodiments, the data processor 110 can be configured to determine the combinations of positioning detectors 120 and positioning sensors 102 which provide reliable data, for example by evaluating the signal exchange between a respective one of the positioning detectors 120 and a respective one of the position sensors 102 for various combinations of positioning detectors 120 and position sensors 102. Moreover, in some embodiments, the data processor 110 can be configured to determine the positioning sensors 102 which provide reliable data, for example by evaluating the signal exchange between the positioning sensor device 104 and each of the position sensors 102.

In still other embodiments, a redundancy of certain arrangement components, for example of positioning detectors 120, can also be used to increase the accuracy of the above described procedures.

In a further embodiment, the data processor 110 can be configured to determine if the data collected by the data collector 108 and/or the data processed by the data processor 110 is within one or more predetermined value ranges. For example, a first value range can indicate whether or not it is safe to operate the vehicle 100. For example, if an axle of a car or a train is deformed or broken, resulting in a displacement of position sensors 102 attached to the axle, the data processor 110 can be configured to determine that it is not safe to operate the vehicle.

In another example, a second value range can indicate whether or not the vehicle 100 and/or the occupants of the vehicle 100 are in a critical situation, such as during or after an accident. For example, if after a crash of the vehicle 100 such as a car crash or an airplane crash the passenger cabin is deformed to a certain degree, resulting in a displacement of position sensors 102 attached to an outer periphery of the passenger cabin, the data processor 110 can be configured to determine that the vehicle 100 and/or the occupants of the vehicle 100 are in a critical situation.

In the above embodiments, the positioning sensor device 104 and/or the components of the positioning sensor device 104 such as the positioning detectors 120 were considered to remain stationary on their original positions while the position sensors 102, while remaining securely attached to the respective points on the vehicle and/or on a vehicle component, were displaced from their original positions, for example due to deformation of the vehicle and/or of the vehicle component, or due to displacement of the vehicle component. However, in some embodiments, it can also occur that the positioning sensor device 104 and/or its components, while remaining securely attached to the respective points on the vehicle and/or on a vehicle component, can be displaced from their original positions, for example due to deformation of the vehicle and/or of the respective vehicle component, or due to displacement of the respective vehicle component. These situations are dealt with in an analogous manner as described in the above examples, the data processor 110 being configured to detect whether one or more position sensors 102 are displaced from their original positions with respect to the positioning sensor device 104 or if the positioning sensor device 104 and/or one or more of its components are displaced with respect to the position sensors 102 or if both one or more position sensors 102 and one or more components of the positioning sensor device 104 are displaced, for example by evaluating the signal exchange between a respective one of the position sensors 102 and a respective one of the positioning detectors 120 for various combinations of position sensors 102 and positioning detectors 120.

Again referring to FIG. 1, after the data processor 110 has processed the data collected by the data collector 108, the data transmitter 112 transmits the data processed by the data processor 110 to an external receiver 114, including the data provided by the location detection device 106 and/or the data provided by the vehicle data sensors 118.

In some embodiments, the data received by the external data receiver 114 can be provided to a server 122. For example, the server 122 can be a centralized server located elsewhere and configured process, e.g. to manage and to analyze, data received from various vehicles comprising a vehicle status monitoring system according to an embodiment via the external data receiver 114.

For example, the server 122 can be connected to local authorities like the police, ambulance services, traffic systems or telecom companies, where it can be used for various purposes. For example, the server 122 can contain data and software applicable and efficient to handle all of the data provided by all of the features of embodiments via the external receiver 114, as for example an updated street map of the respective country and/or software for processing the data provided by the components of the vehicle status monitoring arrangement, for example by the positioning sensor device 102, the location detection device 106 and/or the vehicle data sensors 118 such as an accelerometer. Moreover, for example, via the server 122 any accident can be monitored and an automatic proclamation warning should be displayed by the software which is responsible to handle the parameters coming from the server 122 and for displaying it on a screen in front of the responsible users. For example, the data received by the external receiver 114 can be analyzed and/or visualized in a three dimensional view in order to estimate the damage or the deformation of the vehicle 100 after an accident, thus for example allowing a first evaluation of the severity of possible injuries to the vehicle occupants resulting from the accident. As certain types of accidents have typical damage patterns and as a consequence also typical injury patterns, the data provided via the data processor 110 to the external receiver 114 can provide valuable information for initiating appropriate supporting measures. Here, the data provided by the location detection device 106 allows a straightforward localization of the vehicle 100. Moreover, the data provided by the vehicle data sensors 118, such as for example data on the speed of the vehicle 100 before the accident, can help to assess the situation.

In another embodiment, the data can be analyzed and/or visualized in order to estimate the endangerment of persons or for the environment near a crash site. For example, when a tank waggon with an explosice load meets with an accident, the data on the deformation of the tank can provide quite valuable information to initiate appropriate supporting measures.

In still another embodiment, the data can be analyzed and/or visualized to help determining if the vehicle 100 is safe to operate. This can help local authorities such as the police to identify vehicles which should be shut down or which need repair. Moreover, this data can be used in workshops to help identifying deformed and/or broken vehicle components.

Once the data is transmitted from the data processor 110 to the external receiver 114 via the data transmitter 112, the data can also be stored for later use. This can, for example, be quite helpful in analyzing the circumstances of an accident. In this way, any accident can be analyzed, which makes life much easier for certain sectors, e.g. insurance companies, traffic sector, etc.

The data transmitter 112 can transmit the data processed by the data processor 110 applying any wireless communication method. For example, the data can be transmitted via one or more (cellular) mobile communications networks such as for example GSM, UMTS, CDMA200, FOMA, or EDGE. Moreover, the data can be transmitted via a wireless internet connection such as WLAN, or via conventional radio communication in appropriate frequency bands.

In some embodiments, the data processed by the data processor 110 may be transmitted to the external receiver 114 via the data transmitter 112 only if the data processor 110 determined that the data collected by the data collector 108 and/or the data processed by the data processor 110 is not within a predetermined value range. Referring to the embodiments above, in this way, for example, it can be possible to transmit the data processed by the data processor 110 to the external receiver 114 only if based on the respective value ranges it has been determined that operation of the vehicle 100 is not safe any more or if it has been determined that the vehicle 100 and/or the occupants of the vehicle 100 are in a critical situation.

Moreover, as also indicated in FIG. 1, the vehicle 100 may also include one or more output devices 116 for outputting the data processed by the data processor 110 to a vehicle occupant, for example to a driver of a car or to a pilot of an airplane. The output device 116 can provide, for example, an optical message and/or an acoustic message and/or a tactile message to a vehicle occupant. For example, the output device 116 may include a screen and/or a head-up-display and/or speakers and/or a vibration element. For example, the output device 116 can be connected to the vehicle's speakers. Moreover, in some embodiments, the data processor 110 can be configured to provide a warning message to a vehicle occupant via the output device 116, if the data received from the data collector 108 and/or the data processed by the data processor 110 is not within a predetermined value range. For example, different predetermined value ranges can be defined to correspond to different degrees of severity of the problems causing infringement of the respective value ranges, and the data processor 110 can be configured to provide messages to the driver via the output device 116 signalling this severity. For example, in an optical message, different degrees of severity can be signalled using different colors such as green, yellow, or red, signalling an increasing severity of the underlying problem. Moreover, in some embodiments, the messages provided to the vehicle occupant can contain information on what kind of action is required by the vehicle occupant.

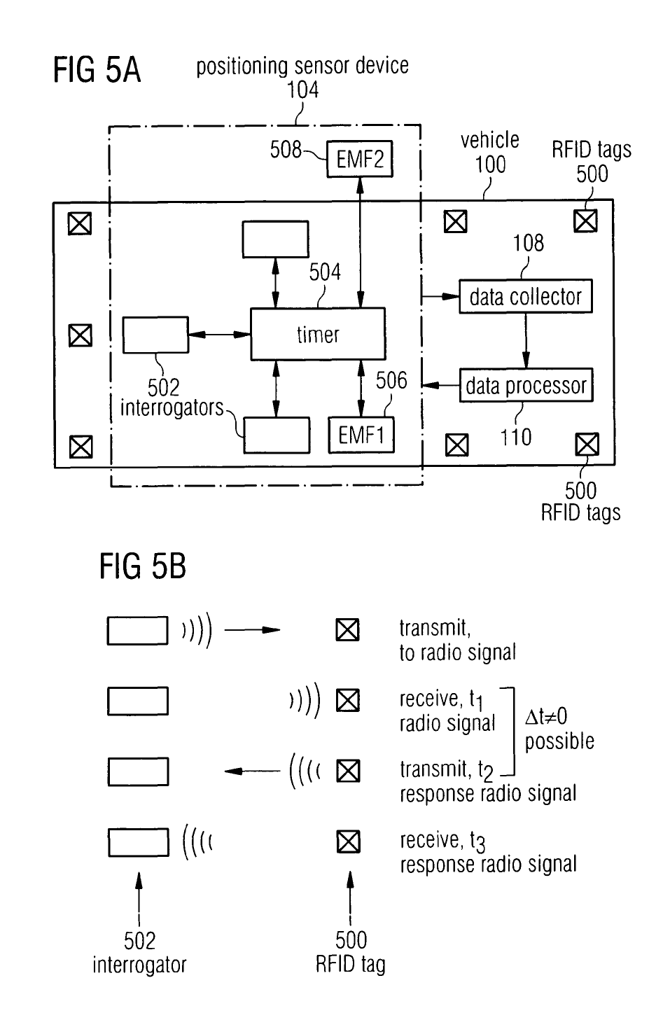

In some embodiments, the position sensors 102 can be radio frequency identification (RFID) transponders, also referred to as RFID tags. FIG. 5A is a block diagram schematically showing a vehicle 100 including a vehicle status monitoring arrangement according to an embodiment. Referring to FIG. 5A, the vehicle 100 may include a positioning sensor device 104, a data collector 108, a data processor 110, and a plurality of RFID tags 500 acting as the position sensors 102. For the sake of clarity, other components such as the location detection device 106, the data transmitter 112, the output device 116, and the vehicle data sensors 118 are not shown in FIG. 5A. As depicted in FIG. 5A, the positioning sensor device 104 may include one or more interrogators 502 and/or a timer 504, and/or one or more EMF meters, in FIG. 5A represented by two EMF meters 506 and 508.

The RFID tags 500 can be of active type, i.e. including a battery powering the respective RFID tag, or of passive type, i.e. receiving their operation energy from an external electromagnetic field. RFID tags as such are common knowledge and will thus not be described in detail in the present description. The RFID tags 500 may each include an integrated circuit for storing information, such as for example an identification code allowing identification of each of the RFID tags 500, and an antenna for receiving and transmitting radio signals. The RFID tags 500 are securely attached to predetermined and well-defined points on the vehicle 100 and/or on one or more vehicle components, in a manner already described to a great extent above for the general case of attaching position sensors 102. For example, the RFID tags 500 can be sticked or attached to the body of the vehicle 100 in a way so as to shape the vehicle 100 in a three dimensional shape. In another example, the RFID tags can be located in the ceiling, the bottom, the front and the back of a car.

The interrogators 502 can be configured to transmit radio signals to the RFID tags 500 and to receive radio signals from the RFID tags 500 on a suitable operating radio frequency. For example, the interrogators 500 can send ping requests to the identified RFID tags 500. If the RFID tags 500 are passive RFID tags, the RFID tags 500 are powered by the energy contained in the electromagnetic field transmitted by the interrogators 502.

Moreover, the positioning sensor device 104 may include a timer 504. The timer 504 may be configured to measure the run times of radio signals between a respective one of the interrogators 502 and a respective one of the RFID tags 500 for various combinations of interrogators 502 and RFID tags 500. For example, the timer 504 can start when a ping is initiated by one of the interrogators 502 and stop when the reply is received from a respective one of the RFID tags 500.

In an embodiment, the timer 504 may be a timer capable of resolving nanoseconds, or a timer capable of resolving picoseconds, or a timer with a time resolution better than picoseconds. The positioning sensor device 104 including the timer 504 may provide the run times of the radio signals for various combinations of interrogators 502 and RFID tags 500 to the data collector 108, which in turn provides this data to the data processor 110.

As schematically depicted in FIG. 5B, the run time of a radio signal can be the total time delay between transmission of a radio signal by one of the interrogators 502, reception of the radio signal by one of the RFID tags 500, transmission of a response radio signal by the RFID tag, and reception of the response radio signal by the interrogator. The run time can include time delays due to the time needed for signal processing in the various system components, such as for example a time delay between reception of the radio signal by the RFID tag and transmission of the response radio signal by the RFID tag. In any case, the run time may depend on a signal propagation time required for the radio signals to cover the distance between the respective one of the interrogators 502 and the respective one of the RFID tags 500, and the data processor 110 can be configured to decompose the run time in its various components. By way of example, the data processor 110 can be configured to extract the signal propagation times from the run times.

In some embodiments, the response radio signal transmitted by one of the RFID tags 500 in response to a signal, such as a ping received from one of the interrogators 502, can contain information on an RFID tag number and/or, in case the RFID tags 500 are active RFID tags being powered by an internal battery, on the battery level of the respective RFID tag. If the RFID tags 500 are passive RFID tags and/or use a continuous power feeder, there is no need to measure the battery level in each ping.

In some embodiments, the data processor 110 can be configured to calculate data on the distance between a respective one of the interrogators 502 and a respective one of the RFID tags 500 based on the run time of the radio signal between the respective interrogator and the respective RFID tag for various combinations of interrogators 502 and RFID tags 500.

For example, according to an embodiment, the data processor 110 can be configured to calculate the distance between a respective one of the interrogators 502 and a respective one of the RFID tags 500 based on the run time of the radio signal between the respective interrogator 502 and the respective RFID tag 500 for various combinations of interrogators 502 and RFID tags 500.

In another example, the data processor 110 can be configured to evaluate changes in the run times of radio signals between a respective one of the interrogators 502 and a respective one of the RFID tags 500 for various combinations of interrogators 502 and RFID tags 500 with respect to a specified reference run time data pattern stored in the data processor 110. This can be provided for example when decomposition of the run times of the radio signals into their various components is not possible or not desired.

In the embodiments above, the data processor 110 may be configured to calculate data on the distances between a respective one of the interrogators 502 and a respective one of the RFID tags 500 for various combinations of interrogators 502 and RFID tags 500 based on the run times of radio signals between the respective interrogator and the respective RFID tag.

Moreover, the data processor 110 can be configured to calculate data on the spatial positions of the RFID tags 500.

For example, the data processor 110 can be configured to calculate data on the spatial positions of the RFID tags 500 based on the data on the distances between a respective one of the interrogators 502 and a respective one of the RFID tags 500. For example, the data processor 110 can be configured to calculate the spatial position of each of the RFID tags 500. To enable the data processor 110 to calculate data on the spatial positions of the RFID tags 500 in three dimensions, in some embodiments, a plurality of interrogators 502 can be used in order to have different dimensions detection for each of the RFID tags 500. In some embodiments, four or more interrogators 502 can be used to interrogate each one of the RFID tags 500. For example, RFID tags 500 as well as interrogators 502 can be arranged on all six sides of the vehicle 100. In another aspect, for any long or tall vehicle (e.g. an aircraft) one may need to install more than one interrogator 502. In another embodiment, the RFID detection can occur in a cubic shape virtual environment, i.e. the RFID tags 500 are arranged in such a way as to be arranged on imaginary cubes, whereas the interrogators 502 are arranged at the centers of the imaginary cubes. In still another embodiment, the interrogators 502 can be installed in the corners of the vehicle 100 and/or in the center of the vehicle 100. As already conducted above, an increasing number of interrogators 502 can also be used to increase the accuracy and/or the reliability of the position detection.

The positioning sensor device 104 may include one or more electromagnetic field (EMF) meters, also referred to as EMF detectors, installed on or within the vehicle 100. The EMF meters may be configured to detect electromagnetic fields. In the example shown in FIG. 5A, the positioning sensor device 104 may include two EMF meters 506 and 508. The first EMF meter 506 is installed within the vehicle 100, whereas the second EMF meter 508 is installed outside of the vehicle 100. The EMF meters 506, 508 are configured to determine data on electromagnetic influences both inside and outside of the vehicle 100, as for example parasitic electromagnetic fields originating from the motor electronics of the vehicle 100 or interfering electromagnetic fields radiated by nearby RFID devices located near the vehicle 100. The positioning sensor device 104 including the EMF meters 506, 508 can provide the data generated by the EMF meters 506, 508, such as field strenghth and/or frequency range of the electromagnetic fields detected by the EMF meters 506, 508, via the data collector 108 to the data processor 110.

The data processor 110 can be configured to analyze the data provided by the EMF meters 506, 508 in order to determine, if the interaction between the RFID tags 500 and the interrogators 502 was affected by internal and/or external electromagnetic influences. For example, the data processor 110 can be configured to determine if the data provided by the EMF meters 506, 508 is within a predetermined value range, and based on this to determine if the data provided by the positioning sensor device 104 is reliable or not. In an embodiment, an occupant of the vehicle 100 can be warned via the output device 116, if an internal electromagnetic field detected by the EMF 506 within the vehicle 100 has reached a specific level and is disturbing the RFID signals. In another embodiment, if an electromagnetic field is detected by the EMF 508 outside of the vehicle 100, the data processor 110 can compare the data provided by the EMF 508 to the data provided by the EMF 506 within the vehicle 100 and warn an occupant of the vehicle 100 and/or discard the data provided by the positioning sensor device 104 in the respective period of time, if evaluation of the data provided by the EMF 506 reveals that the electromagnetic field has disturbed the signal exchange between the RFID tags 500 and the interrogators 502 in the respective period of time.

In some embodiments, the data processor 110 can be configured to determine the combinations of RFID tags 500 and interrogators 502 which provide reliable data by evaluating the signal exchange between a respective one of the interrogators 502 and a respective one of the RFID tags 500 for various combinations of interrogators 502 and RFID tags 500. For example, if a passenger entered some object into the vehicle 100 that prevents a respective one of the RFID tags 500 from replying to a respective one of the interrogators 502, the data processor 110 can cause the output device 116 to output a warning message warning an occupant of the vehicle 100. Analogously, in another example, when a respective one of the interrogators 502 is unable to receive signals from any of the RFID tags 500 or the signals received from the RFID tags 500 are weak while at the same time the EMF meters 506, 508 did not detect any disturbing electromagnetic fields, this can imply that the respective interrogator is disturbed by some object. In still another example, when the signal exchange between a repective one of the RFID tags 500 and a respective one of the interrogators 502 is disturbed while at the same time the EMF meters 506, 508 detect disturbing electromagnetic fields, this can imply that the disturbing electromagnetic fields are hindering signal exchange between the respective RFID tag 500 and the respective interrogator 502.

For illustration, in some embodiments, after the vehicle 100 is being switched on, the interrogators 502 may check for the latest coordinates of the installed RFID tags 500, the location detection device 106, for example a GPS receiver, locates the coordinates and the location of the vehicle 100, the accelerometer reads the position or positioning of the vehicle 100, and the chip for gathering all of the vehicle's system information connects to some of the vehicle's components such as for example tires, lights, tableau system, gasoline system etc. so as to gather information such as gasoline rate etc. Subsequently, in some embodiments, all of this information can be sent to the server 122 connected to the external receiver 114, for example via a WLAN connection using a WLAN device or WLAN chip, where the nearest WLAN connection and/or other internet connection should be located in order to send this information to the server 122.

In the embodiments described above, the data processor 110 may be configured to calculate data on the positions of the RFID tags 500 based on the run times of radio signals between various combinations of interrogators 502 and RFID tags 500. However, in some embodiments, the data on the positions of the RFID tags 500 can also be determined based on the measurement of the orientation and/or the amplitude of the electromagnetic fields originating from the RFID tags 500. For this purpose, some embodiments may include an electromagnetic field measurement device configured to determine predetermined properties of the electromagnetic fields originating from the RFID tags 500, such as orientation and/or amplitude of the electromagnetic fields. Moreover, in some embodiments, the data processor 110 may be configured to calculate data on the spatial positions or on changes in the spatial positions of the plurality of position sensors 102 based on the data provided by the electromagnetic field measurement device.

In the embodiments described above, the data collected by the data collector 108 may be processed by the data processor 110, and the data processed by the data processor 110 may be sent to the external receiver 114 via the data transmitter 112.

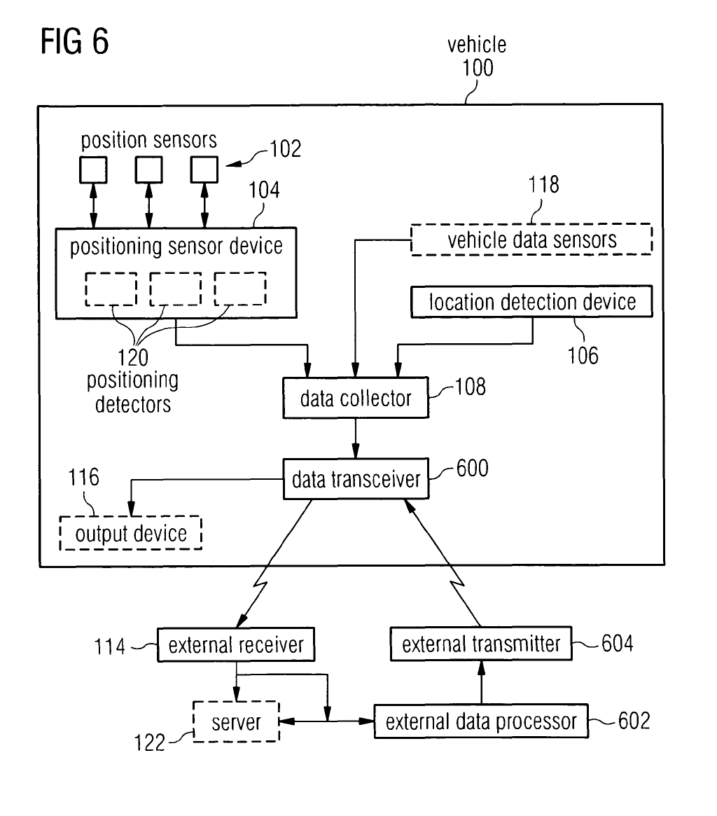

FIG. 6 is a block diagram schematically showing a vehicle 100 including a vehicle status monitoring arrangement according to another embodiment. Referring to FIG. 6, a vehicle status monitoring arrangement according to an embodiment may include a plurality of position sensors 102, a positioning sensor device 104, a location detection device 106, a data collector 108, and a data transceiver 600. Moreover, the vehicle status monitoring arrangement may include an output device 116 and/or various vehicle data sensors 118. Furthermore, in some embodiments, the positioning sensor device 104 may include one or more positioning detectors 120. In difference to the embodiment illustrated in FIG. 1, in the embodiment illustrated in FIG. 6 the data collected by the data collector 108 may be provided to the data transceiver 600. The data transceiver may be configured to transmit the data collected by the data collector 108 to an external receiver 114 and to receive data transmitted by an external transmitter 604. Referring to FIG. 6, the data transceiver 600 inter alia transmits the data related to the spatial positions of the plurality of position sensors 102 as provided by the positioning sensor device 104, as well as the other data collected by the data collector 108, to the external receiver 114.

The external receiver 114 can provide the data received from the data transceiver 600 to an external data processor 602. For example, the data received by the external receiver 114 can be provided to the external data processor 602 via the server 122. The external data processor 600 can have the same functionality as the data processor 110 described above. For example, the external data processor 602 can process the data collected by the data collector 108. The external data processor 602 can inter alia be configured to process the data related to the spatial positions of the plurality of position sensors 102 as provided by the positioning sensor device 104 so as to calculate data on the spatial positions and/or on changes in the spatial positions of the plurality of position sensors 102 in one or more of the above-described manners. By way of example, the data processor 602 can calculate the position of each of the position sensors 102, for example with respect to a specified coordinate system. Moreover, the data processor 602 may be configured to evaluate changes in the data originating from each of the position sensors 102 with respect to a reference data pattern. As described above, the data processor 602 may be configured to evaluate the data on the positions or on changes in the positions of the plurality of position sensors 102 to determine changes in the shape of predetermined portions of the vehicle 100. Moreover, the data processor 602 may be configured to evaluate the data on the positions and/or on changes in the positions of the plurality of position sensors 102 to determine displacements of predetermined vehicle components and/or to detect broken and/or deformed vehicle components. Moreover, the external data processor 602 can also provide data to the server 122, for example to allow further use of the data processed by the data external processor 602 and/or management of the data processed by the external data processor 602.

In a manner described above for the data processor 110, the data processed by the external data processor 602 can, for example, be analyzed and/or visualized in order to estimate the damage or the deformation of the vehicle 100 after an accident, thus for example allowing a first evaluation of the severity of possible injuries to the vehicle occupants resulting from the accident, the data provided by the location detection device 106 allowing a straightforward localization of the vehicle 100. In another embodiment, the data processed by the external data processor 602 can for example be analyzed in order to estimate the endangerment of persons or for the environment near a crash site, or to help determining if a certain vehicle is safe to operate.

In the embodiment illustrated in FIG. 6, the data processed by the external data processor 602 or part of the data processed by the external data processor 602 can be transmitted to the data transceiver 600 via an external transmitter 604. The external transmitter 604 may be configured to transmit the data processed by the external data processor 602 to the data transceiver 600. The data transceiver 600 can inter alia be configured to mediate communication between the external data processor 602 and components of the vehicle status monitoring arrangement installed on or within the vehicle 100, such as for example the output device 116. For example, the output device 116 can be configured to output the data received by the data transceiver 600 from the external transmitter 604 to an occupant of the vehicle 100. In this way, it is for example possible to provide a warning message to an occupant of the vehicle 100. Moreover, the data transceiver 600 can be configured to communicate with other components of the vehicle status monitoring system, for example with the positioning sensor device 104 and/or with the vehicle data sensors 118. For example, in this way the external data processor 602 can initiate routines such as a system check of the vehicle status monitoring arrangement and/or collection of a reference data pattern by sending an accordant command via the external transmitter 604 to the data transceiver 600.

Data exchange between the data transceiver 600 and the external receiver 114 and between the external transmitter 604 and the data transceiver 600 can be carried out applying any wireless communication method. For example, the data can be exchanged via one or more (cellular) mobile communications networks such as for example GSM, UMTS, CDMA200, FOMA, or EDGE. Moreover, the data can be exchanged via a wireless internet connection such as WLAN, or via conventional radio communication in appropriate frequency bands.

According to another embodiment, in order to have the maximum benefit of it, all vehicles should be equipped with a vehicle status monitoring arrangement according to an embodiment. For example, all cars should have a vehicle status monitoring arrangement according to an embodiment. For example, the data collected by the data collector 108 and/or the data processed by the data processor 110, in particular data concerning speed and position of each car, can be provided to the server 122 connected to the external receiver 114. The server 122 can be configured to analyze the data being received from each vehicle. For example, all car movements can be recorded for security reasons. For example, the server 122 can analyze an accident by evaluating the speed of a car A and the speed of a car B (if there are two cars involved) before an accident. Here, car B should also be equipped with a vehicle status monitoring arrangement according to an embodiment. Moreover, the server 122 can analyze deformations of the cars originating from the accident. In another embodiment, the occupants of the car A can ask to locate the other car B via the server 122. For this purpose, the plate number of each of the cars can be recorded and assigned to a fixed IP address, which for example can belong to a WLAN chip installed in the respective car. However, in this implementation, the car B should accept localization by the car B, for example via receiving a message in a screen and confirming the message. On the other hand, for example police cars can be allowed to locate any car freely without any condition.

In another embodiment, if a danger is about to occur, the occupants of a vehicle, in particular a driver of a car, can be warned by transmitting a warning message from the server 122 or from the external data processor 602 via the external transmitter 604 to the data transceiver 600, which in turn can provide the warning message to the output device 116. In this way, for example, the driver of the car can be warned if another car is crossing through with high speed, where the output device 116 can deliver a warning message to the driver of the car, for example by playing a warning message in the car's speakers and/or by displaying the sudden danger on a screen showing for instance a red arrow.

In still another embodiment, the server 122 can be configured to evaluate the positions and the speed of all vehicles, for example of all cars, equipped with a suitable vehicle status monitoring system according to an embodiment. In one embodiment, the output device 116, such as a screen, can serve a car user by providing him the crowded highways at that moment and/or the nearest path to a desired destination by avoiding any high traffic in order to reach the destination faster and/or warn him if he took such a way that he will be stuck for a predetermined amount of time. For example, the analysis software installed in the server 122, possibly being a centralized server, can give each car the movement report of the cars on the highways and an estimated time of when the crowded way may move and breathe freely.

In some embodiments, in a way or another, the vehicle status monitoring arrangement according to an embodiment can act as a black box installed in aircrafts, but this time in the server 122, possibly a centralized server.

The data stored in a black box of an airplane can be lost, for example because of high temperature or the like, or the box itself can be lost. With the vehicle status monitoring arrangement according to an embodiment, the data will not be lost any more, since it can be transmitted to the external receiver 114, where it can be safely stored. Such a monitoring arrangement according to an embodiment, can be given to all vehicles and aircrafts and the like to be warned and analyzed correctly in a way to benefit from it the most.

According to an embodiment, the components or devices of the vehicle status monitoring arrangement may be powered by the power supply of the vehicle 100, for example the devices can be attached to the battery of a car in order to use its energy to work. For example, when the vehicle is being switched on, the electrical energy of a battery of the vehicle 100 can be supplied to the components of the vehicle status monitoring system.

However, in some embodiments, the vehicle status monitoring system may further include a backup battery to give the components or devices the ability to keep on running to be able to send information even in case the components of the vehicle status monitoring arrangement cannot receive any electrical power from the power supply of the vehicle 100, for example if the electrical connection is interrupted in case of a strong accident or the like or when the vehicle 100, for example being a car, is switched off due to some other reason. For example, the car may have an accident when the car is switched off, so for that the backup battery will also serve the case. In another embodiment, the backup battery can be used when an accident occurs to keep the updates alive in order to allow location of the vehicle 100 using the data provided by a GPS, and in order to allow acquiring data on the displacement of the positioning sensors 102, e.g. to read the misplaced RFID active tags 500 coordinates, and then to report the accident analysis to the server 122 via the external receiver 114.

According to some embodiments, the backup battery is recharged from the vehicles power supply when needed, for example in case of the vehicle 100 being a car the backup battery can be recharged from the battery of the car.

According to an embodiment, the data collected by the data collector 108 and/or the data processed by the data processor 110, for example data provided by a GPS receiver and/or data provided by an RFID-based positioning sensor device 104 and/or any other vehicle data such as vehicle speed, exact location of the vehicle in centimeters and shape of the vehicle, can be transmitted to the external receiver 114 and to the server 122 as real time information. In an implementation with the vehicle 100 being a car and the position sensors 102 being RFID tags, when the car moves, the interrogators 502 can begin to interrogate the RFID tags 500 every second, the location detection device 106, for example a GPS receiver, can also detect the location of the car every second, and then this information can be sent to the server 122 via the external receiver 114.

In another embodiment, the vehicle 100 may further include a temporary data storage device configured to record and store the data collected by the data collector 108 and/or the data processed by data processor 110 and/or all of the movements of the vehicle 100 when there is no connectivity while the vehicle 100 is switched on, i.e. when the data transmitter 112 and/or the data transceiver 600 are unable to transmit the data to the external receiver 114. When a connection is available again, the data can be transmitted to the external receiver 114 and the temporary data storage device can be cleaned up, i.e. the previous data stored on the temporary data storage device can be cleared. For example, when the data is exchanged via a wireless internet connection such as WLAN, and WLAN is not available at a certain time, the datastorage device can record all of the data.

Various embodiments provide a vehicle equipped with an arrangement for monitoring a status of the vehicle. By way of example, various embodiments provide a vehicle including a status monitoring arrangement capable of providing data related to the spatial positions of a plurality of position sensors arranged at predetermined points on the vehicle.

Various embodiments provide a possibility to remotely track the positions or changes in the positions of specified points on or within the vehicle, for example in order to allow conclusions on displacements of specified vehicle components or on deformations of the vehicle, e.g. of the passenger cabin.

Various embodiments provide a vehicle including a vehicle status monitoring system, wherein the vehicle status monitoring system includes a plurality of position sensors arranged at predetermined points on the vehicle and/or on one or more vehicle components, a positioning sensor device configured to provide data related to the spatial positions of the plurality of position sensors, a location detection device configured to detect the location of the vehicle, a data collector configured to collect the data provided by the positioning sensor device and the location detection device, a data processor configured to process the data collected by the data collector, and a data transmitter configured to transmit the data processed by the data processor to an external receiver.

In another embodiment, a vehicle is provided having a vehicle status monitoring system, wherein the vehicle status monitoring system may include a plurality of position sensors arranged at predetermined points on the vehicle and/or on one or more vehicle components, a positioning sensor device configured to provide data related to the spatial positions of the plurality of position sensors, a location detection device configured to detect the location of the vehicle, a data collector configured to collect the data provided by the positioning sensor device and the location detection device, and a data transceiver configured to transmit the data collected by the data collector to an external receiver and to receive data from an external transmitter.

According to another embodiment, the position sensors are RFID tags.

According to another embodiment, the positioning sensor device may include one or more interrogators configured to transmit signals to the RFID tags and to receive signals from the RFID tags.

According to another embodiment, the positioning sensor device may further include a tuner configured to measure a run time of a radio signal between a respective one of the plurality of RFID tags and a respective one of the plurality of interrogators.

According to another embodiment, the positioning sensor device may further include an electromagnetic field (EMF) meter installed on or within the vehicle, the EMF meter being configured to detect an electromagnetic field.

According to another embodiment, the location detection device may be a satellite based detection device, e.g. a global positioning system detection device.

According to another embodiment, the data processor is configured to determine whether or not the data collected by the data collector is within a predetermined value range, and the data transmitter transmits the data processed by the data processor only if it was determined that the data collected by the data collector is not within the predetermined value range.

According to another embodiment, the vehicle status monitoring system may further include an output device configured to output the data processed by the data processor and/or the data received by the data transceiver to a vehicle occupant.

According to another embodiment, the vehicle can be a car, a train, an aircraft, a ship, or any other type of vehicle.

According to another embodiment, the vehicle status monitoring system may further include various vehicle data sensors configured to provide vehicle related data.

According to another embodiment, the data collector can be configured to collect the data provided by the vehicle data sensors.

According to another embodiment, the position sensors are securely attached to predetermined and well-defined points on the vehicle and/or on one or more vehicle components, so as to reflect the three dimensional shape of the vehicle and the spatial positions of predetermined vehicle components.

According to another embodiment, the positioning sensor device may include one or more components.

According to another embodiment, the positioning sensor device may include one or more positioning detectors, where each of the positioning detectors interacts with one or more of the plurality of position sensors to generate data related to the spatial positions of the plurality of position sensors.

According to another embodiment, the positioning sensor device and/or the components constituting the positioning sensor device are securely attached to predetermined and well-defined points on the vehicle and/or on one or more vehicle components.

According to another embodiment, the positioning sensor device interacts with the position sensors so as to generate data related to the spatial positions of the position sensors.

According to another embodiment, the data processor may be configured to process the data related to the spatial positions of the plurality of position sensors so as to calculate data on the positions of the plurality of position sensors.

According to another embodiment, the data processor may be configured to calculate the position of each of the position sensors.

According to another embodiment, the data processor may be configured to evaluate changes in the data originating from each of the position sensors with respect to a specified reference data pattern stored in the data processor.

According to another embodiment, the reference data pattern may be a fixed reference data pattern.

According to another embodiment, the reference data pattern may be an adjustable data pattern which can be collected under predetermined circumstances.

According to another embodiment, the adjustable reference data pattern may be collected in response to manual operation of a specified switch by a vehicle occupant.

According to another embodiment, the adjustable reference data pattern may be collected automatically at the beginning of each travel of the vehicle.

According to another embodiment, the data processor may be configured to use the data on the positions of the plurality of position sensors to determine the shape of predetermined portions of the vehicle and/or changes in the shape of predetermined portions of the vehicle.

According to another embodiment, the data processor may be configured to use the data on the positions of the plurality of position sensors to determine the positioning of predetermined vehicle components and/or displacements of predetermined vehicle components.

According to another embodiment, the data processor may be configured to use the data on the positions of the plurality of position sensors to detect broken and/or deformed vehicle components.

According to another embodiment, the use of more than one positioning detector may be provided to enable the data processor to determine the spatial positions of the position sensors. In other words, the data processor may be configured to use more than one positioning detector to determine the spatial positions of the position sensors.

According to another embodiment of the invention more than one positioning detector is used to increase the reliability of the vehicle status monitoring arrangement.

According to another embodiment, the data processor may be configured to determine the position sensors which may e.g. provide reliable data.

According to another embodiment, the data processor may be configured to determine the position sensors which provide (reliable) data by evaluating the signal exchange between the positioning sensor device and a respective one of the position sensors for each of the position sensors.

According to another embodiment, the data processor may be configured to determine the combinations of positioning detectors and position sensors which provide (reliable) data.

According to another embodiment, the data processor may be configured to determine the combinations of positioning detectors and position sensors which provide (reliable) data by evaluating the signal exchange between a respective one of the positioning detectors and a respective one of the position sensors for various combinations of positioning detectors and position sensors.

According to another embodiment, the data processor may be configured to determine if the data collected by the data collector and/or the data processed by the data processor is within a predetermined value range.

According to another embodiment, the data processor may be configured to detect whether one or more position sensors are displaced from their original positions or if the positioning sensor device and/or one or more of its components are displaced from their original positions or if both one or more position sensors and one or more components of the positioning sensor device are displaced from their original positions.

According to another embodiment, the data transmitter may be configured to transmit the data processed by the data processor applying any wireless communication method.

According to another embodiment, the data transmitter may be configured to transmit the data processed by the data processor via a (cellular) mobile communications network such as for example GSM, GPRS, UMTS, CDMA200, FOMA, or EDGE.

According to another embodiment, the data transmitter may be configured to transmit the data processed by the data processor using a wireless internet interface and/or internet connection such as WLAN.

According to another embodiment, the data transmitter may be configured to transmit the data processed by the data processor via conventional radio communication.

According to another embodiment, the output device may be configured to provide an optical message and/or an acoustic message and/or a tactile message to a vehicle occupant.

According to another embodiment, the output device may include a screen and/or a head-up-display and/or speakers and/or a vibration element.

According to another embodiment, the data processor may be configured to provide a message to a vehicle occupant via the output device, if the data received from the data collector and/or the data processed by the data processor is not within the predetermined value range.

According to another embodiment, the message provided by the output device to the vehicle occupant may contain information on what kind of action is required by the vehicle occupant.

According to another embodiment, the RFID tags can be of active type or of passive type.

According to another embodiment, the positioning sensor device may include a timer configured to measure run times of radio signals between a respective one of the interrogators and a respective one of the RFID tags for various combinations of interrogators and RFID tags.

According to another embodiment, the data processor may be configured to calculate data on the distance between a respective one of the interrogators and a respective one of the RFID tags based on the run times of the radio signals between the respective interrogator and the respective RFID tag for various combinations of interrogators and RFID tags.

According to another embodiment, the data processor may be configured to calculate the distance between a respective one of the interrogators and a respective one of the RFID tags based on the run times of the radio signals between the respective interrogator and the respective RFID tag for various combinations of interrogators and RFID tags.

According to another embodiment, the data processor may be configured to evaluate changes in the run times of the radio signals between a respective one of the interrogators and a respective one of the RFID tags for various combinations of interrogators and RFID tags with respect to a specified reference run time data pattern stored in the data processor.

According to another embodiment, the data processor may be configured to calculate data on the spatial positions of the RFID tags.

According to another embodiment, the data processor may be configured to calculate data on the spatial positions of the RFID tags based on the data on the distances between a respective one of the interrogators and a respective one of the RFID tags for various combinations of interrogators and RFID tags.

According to another embodiment, the data processor may be configured to analyze the data provided by the EMF meter in order to determine if the interaction between the RFID tags and the interrogators was affected by internal and/or external electromagnetic influences.

According to another embodiment, the data processor may be configured to determine if the data provided by the EMF meter is within a predetermined value range.

According to another embodiment, the data processor may be configured to determine if the data provided by the positioning sensor device is reliable or not.

According to another embodiment, the data processor may be configured to determine if the data provided by the positioning sensor device is reliable or not based on the data provided by the EMF meter.

According to another embodiment, the data transceiver may be configured to mediate communication between the external transmitter and components of the vehicle status monitoring arrangement.

According to another embodiment, the data exchange between the data transceiver and the external receiver and the data exchange between the external transmitter and the data transceiver can be carried out by applying any wireless communication method.

According to another embodiment, the data exchange between the data transceiver and the external receiver and between the external transmitter and the data transceiver can be carried out via one or more (cellular) mobile communications networks such as for example GSM, UMTS, CDMA200, FOMA, or EDGE.

According to another embodiment, the data exchange between the data transceiver and the external receiver and between the external transmitter and the data transceiver can be carried out via a wireless internet connection such as WLAN.

According to another embodiment, the data exchange between the data transceiver and the external receiver and between the external transmitter and the data transceiver can be carried out via conventional radio communication.

According to another embodiment, the components of the vehicle status monitoring arrangement are powered by a power supply of the vehicle.

According to another embodiment, the vehicle status monitoring system may further include a backup battery.

According to another embodiment, the backup battery may be recharged from the vehicles power supply.

According to another embodiment, the vehicle status monitoring system may further include a (temporary) data storage device configured to store the data collected by the data collector and/or the data processed by the data processor.

According to another embodiment, a server is provided, where the server is configured to receive data from a vehicle comprising a vehicle status monitoring system according to an embodiment of the invention via the external receiver and to process the received data.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A vehicle, comprising:
a plurality of position sensors arranged at predetermined points on the vehicle and/or on one or more vehicle components;
a positioning sensor device configured to provide data related to the spatial positions of the plurality of position sensors;
a location detection device configured to detect the location of the vehicle;
a data collector configured to collect the data provided by the positioning sensor device and the location detection device;
a data processor configured to process the data collected by the data collector; and a data transmitter configured to transmit the data processed by the data processor to an external receiver.

2. The vehicle according to claim 1, wherein the position sensors are RFID tags.

3. The vehicle according to claim 2, wherein the positioning sensor device comprises one or more interrogators configured to transmit signals to the RFID tags and to receive signals from the RFID tags.

4. The vehicle according to claim 3, wherein the positioning sensor device further comprises a timer configured to measure a run time of a radio signal between a respective one of the plurality of RPID tags and a respective one of the one or more interrogators.

5. The vehicle according to claim 3, wherein the positioning sensor device further comprises an electromagnetic field meter installed on or within the vehicle, the electromagnetic field meter being configured to detect an electromagnetic field.

6. The vehicle according to claim 1, wherein the location detection device is a satellite-based detection device.

7. The vehicle according to claim 1, wherein the data processor is configured to determine whether or not the data collected by the data collector is within a predetermined value range; and wherein the data transmitter transmits the data processed by the data processor only if it was determined that the data collected by the data collector is not within the predetermined value range.

8. The vehicle according to claim 1, further comprising an output device configured to output the data processed by the data processor to a vehicle occupant.

9. A vehicle, comprising:
a plurality of position sensors arranged at predetermined points on the vehicle and/or on one or more vehicle components;
a positioning sensor device configured to provide data related to the spatial positions of the plurality of position sensors;
a location detection device configured to detect the location of the vehicle;
a data collector configured to collect the data provided by the positioning sensor device and the location detection device; and
a data transceiver configured to transmit the data collected by the data collector to an external receiver and to receive data from an external transmitter.

10. The vehicle according to claim 9, wherein the position sensors are RFID tags.

11. The vehicle according to claim 10, wherein the positioning sensor device comprises one or more interrogators configured to transmit signals to the RFID tags and to receive signals from the RFID tags.

12. The vehicle according to claim 11, wherein the positioning sensor device further comprises a timer configured to measure a run time of a radio signal between a respective one of the plurality of RFID tags and a respective one of the one or more interrogators.

13. The vehicle according to claim 11, wherein the positioning sensor device further comprises an electromagnetic field meter installed on or within the vehicle, the electromagnetic field meter being configured to detect an electromagnetic field.

14. The vehicle according to claim 9, wherein the location detection device is a satellite-based detection device, in particular a global positioning system detection device.

15. The vehicle according to claim 9, further comprising an output device configured to output the data received by the data transceiver to a vehicle occupant.

16. A server configured to receive data from a vehicle according to claim 1 via the external receiver and to process the received data.

17. The vehicle according to claim 6, wherein the satellite-based detection device is a global positioning system detection device.

18. The vehicle according to claim 14, wherein the satellite-based detection device is a global positioning system detection device.
